(19) United States
(12) Patent Application Publication
(10) Pub. No.: US 2003/0230909 A1
(43) Pub. Date: Dec. 18, 2003

(54) Enclosure for a vehicle bed

(75) Inventors: Ron Melius, Tenino, WA (US); Mark Trethewey, Centralia, WA (US); Holly Fox, Kent, WA (US); Daniel Beaulaurier, Puyallup, WA (US); Anthony Brooks, Centralia, WA (US)

Correspondence Address: Mitchell P. Brook, Esq., LUCE, FORWARD, HAMILTON & SCRIPPS, Suite 200, 11988 El Camino Real, San Diego, CA, 92130, US

(73) Assignee: Pace-Edwards Company

(21) Appl. No.: 10/167,815

(22) Filed: Jun. 12, 2002

(51) Int. Cl. B60J 11/00

(52) U.S. Cl. 296/98

(57) ABSTRACT

An enclosure for a vehicle bed is provided. The enclosure comprises a retractable cover that includes a control assembly that allows for simple and convenient operation of the cover so that the cover can be positioned in a number of intermediate positions in a vehicle bed. One embodiment of the present invention includes a handle that is offset from a centerline of the retractable cover. Another embodiment of the present invention includes a light that is mounted within the vehicle bed.

### FIELD OF THE INVENTION

This present invention generally relates to vehicles enclosures. More particularly, the invention concerns an enclosure for a vehicle cargo area.

### BACKGROUND OF THE INVENTION

Trucks comprise the largest segment of the automotive market. Their popularity has increased with the popularity of sport utility vehicles (SUVs). This popularity has also spawned several hybrid or crossover vehicle designs that mix elements from both vehicle types. The cargo area in trucks and in some SUVs and hybrids is open and any items placed therein are exposed to the elements and to the risk of theft. Several different types of covers have been developed to enclose the open cargo area in these vehicles. These include canvas or other covers which are strapped, snapped or otherwise attached to the vehicle. However, snapping and unsnapping the multiple snaps is tedious and difficult, which discourages the use of the cargo area. Moreover, the snapped covers do not prevent theft, as they cannot be locked.

Sophisticated retractable covers that use a plurality of inter-locked articulating slats have been developed to provide security for the cargo area. These cover systems include rails that are attached to the vehicle for guiding the cover that is rolled into a canister when not in use. One shortcoming of these systems is that the installation of the rails to the vehicle requires the drilling of precisely located holes in the vehicle, thus permanently marring the vehicle and requiring a skill that is beyond that of the average vehicle owner.

Once installed, it is often desirable to position the cover in a position that may leave a section of the cargo area accessible. To achieve this intermediate positioning, some systems require that the cover be retracted completely into its canister and then deployed to the desired position. Other, more sophisticated systems include an electric motor, but usually, the vehicle must be running to provide the necessary electricity.

Therefore, there exists a need for a vehicle enclosure that can be easily installed by the average owner without the need to drill holes in the vehicle, and easily positioned in any location from completely retracted to fully extended.

### SUMMARY OF THE INVENTION

In order to overcome the deficiencies with known conventional vehicle enclosures, a retractable cover is provided. Briefly, the retractable cover includes a control assembly that allows for simple and convenient operation of the cover so that the cover can be positioned in a number of intermediate positions in the vehicle cargo area. In addition, one embodiment of the present invention includes a handle that is offset from a center line of the retractable cover that allows for convenient positioning of the retractable cover by a user who is standing alongside the vehicle cargo area. Another embodiment of the present invention includes a light that is mounted within the cargo area.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is a second perspective view of one embodiment of the retractable cover system constructed according to the present invention;

FIG. 2 is a second perspective view of the embodiment illustrated in FIG. 1;

FIG. 3 is a perspective sectional view of a canister and rail constructed according to the present inventions;

FIG. 4 is a perspective top view of the control assembly that is located at the end of the retractable cover system illustrated in FIG. 1; and

FIG. 5 is a perspective bottom view of the control assembly illustrated in FIG. 4.

It will be recognized that some or all of the Figures are schematic representations for purposes of illustration and do not necessarily depict the actual relative sizes or locations of the elements shown.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

In vehicles, such as pickup trucks, sport utility vehicles (SUVs), boats, or open-bed trailers, there are open areas that are exposed to the elements. It is often desirable to provide a cover over these areas to secure and protect items placed within them. The present invention provides a retractable cover that is easy to install so that the average vehicle owner can conveniently add the retractable cover to their vehicle. The present invention also includes a method for operating the cover so that the cover can be positioned in a plurality of locations ranging from completely retracted to fully extended and many positions therebetween. The present invention includes several features such as an off-set handle so that the vehicle owner can operate the cover while standing alongside the driver-side of the vehicle. In addition, a light may be provided so that the interior of the cargo area or truck bed can be illuminated.

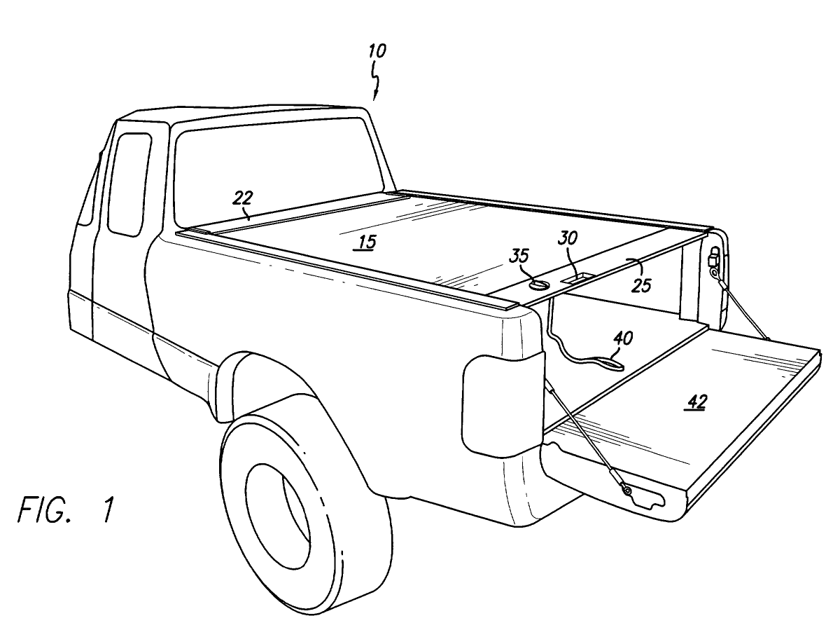

The present invention can be installed on pickup trucks, sport utility vehicles (SUVs), and hybrid and crossover vehicles that combine features found in passenger cars, trucks and SUVs, such as the CHEVROLET AVALANCHE (CHEVROLET and AVALANCHE are trademarks of the General Motors Corporation of Detroit, Mich.). The present invention may also be installed on open-bed trailers, and other types of recreational vehicles, such as boats. One embodiment of the present invention may be installed in the utility bed, or truck bed of a pickup truck. The utility bed is the open area located behind the truck cab that terminates at the truck tailgate. In a preferred embodiment of the present invention, a graspable handle may be employed, as shown in FIGS. 1-2 and 4-5. The handle is offset from the center line 17 of the cover 15. As defined herein, “offset” refers to a location that is not symmetric relative to the center line 17 of the cover 15. For example, a handle that straddles the center line 17 so that a substantially equal amount of the handle is located on either side of the center line 17 would not be offset. Conversely, a handle positioned so that a substantially un-equal amount of the handle is on either side of the center line 17 would be offset. For example, a handle positioned so that the center of the handle is positioned 0.5 inch away from the center line 17 is offset.

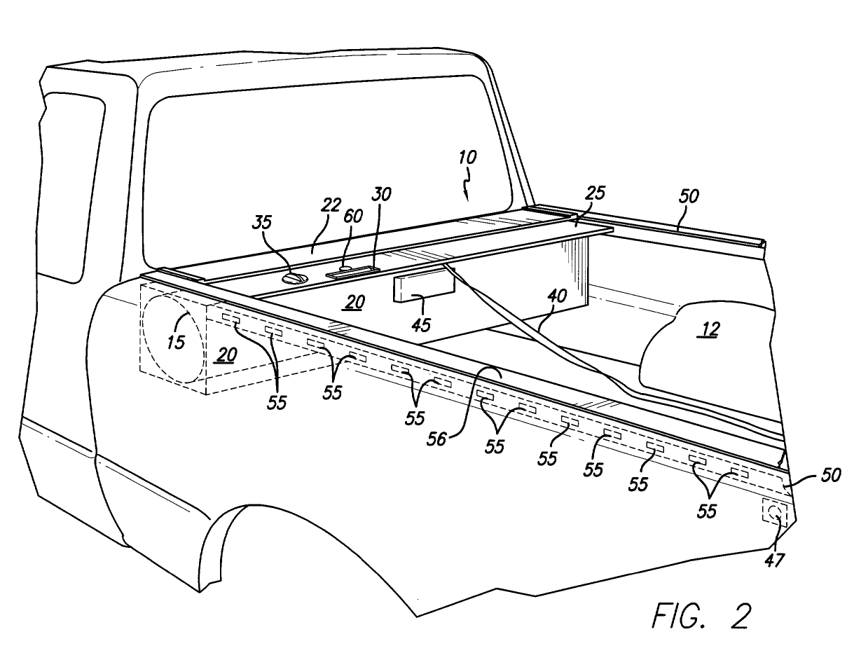

Referring to FIGS. 1 and 2, a retractable cover 10 is illustrated. The retractable cover 10 includes a cover 15 constructed from polymer or other suitable plastic that is attached to a plurality of substantially rectangular aluminum panels (not shown). The cover 15 retracts into the canister 20 by rolling about a spool or reel (not shown). The canister 20 includes a canister top 22 that is substantially flush-mounted at the front end of the truck bed 12. Mounted on the canister 20 is a light 45 that is operated by a light switch 47 conveniently located on the driver-side of the truck bed 12 near the tailgate 42. The light 45 illuminates the truck bed 12 and may be a halogen, fluorescent, incandescent, LED or any other type of suitable light. The light 45 may be located at any position on the canister 20 or may be located in another location in the truck bed 12, such as on a side of the truck bed or located on the tailgate 42. The light 45 may also be located on the control assembly 25. An alternative embodiment of the present invention may employ more than one light 45. For example, two lights 45 may be mounted on the canister 20 or one light 45 may be mounted on the canister 20 and one light may be mounted on the side of the truck bed 12.

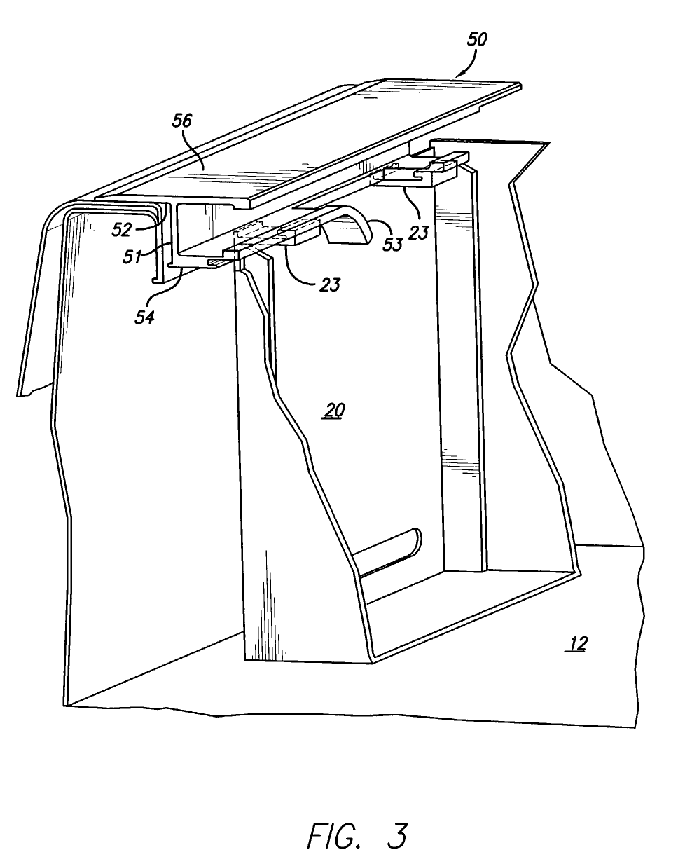

Referring to FIG. 3, a section of the canister 20 is illustrated. The canister 20 includes two grips 23 on each side of the canister 20. The rail 50 includes a T-shaped section 54 (shown in FIGS. 3 and 6-7) that slideably engages the canister grips 23. The canister grips 23 act as channels for the rails 50 so that the canister 20 is suspended from the rails 50. This feature allows for quick and easy installation of the canister 20 in the truck bed 12. Another feature of the present invention is the canister top 22 that is mounted over the canister and directly contacts the rail top surface 56. This allows the canister top 22 to have a flush profile that is visually attractive and minimizes aerodynamic drag.

Again referring to FIG. 3, another feature of the present invention is illustrated. Rail guide 53 extends from the rail 50 toward the interior of the canister 20. In one embodiment of the invention, the rail guide 53 is machined, permitting the formation of the arc shape. Alternatively, the rail guide 53 may be extruded, or comprise a separate part that is attached to the rail 50.

The rail guide 53 directs the cover 15 into and out of the canister 20 as the cover 15 is retracted into and extended out of the canister 20. The rail guide 53 allows the cover 15 to be sufficiently retracted into the canister 20 so that the canister top 22 can positioned substantially flush with the rail top surface 56. In contrast to conventional retractable cover systems, the rail guide 53 is incorporated in the rail 50 and thereby eliminates several parts, decreasing manufacturing costs while improving the aerodynamics of the cover, and again facilitating quick and easy installation of the retractable cover 10.

Rails 50 are mounted alongside the truck bed 12 by clamps (not shown). The rails are secured to the truck bed 12 and provide a track in which the cover 15 slides. The rails 50 also include a plurality of notches 55 that are sized to engage with latches 85. Alternatively, the rails 50 may be constructed to receive a stop strip that would include a plurality of notches 55 that are sized to engage with latches 85. Yet another embodiment of the rails 50 would include projections rather than notches, with the projections sized to engage the latches 85.

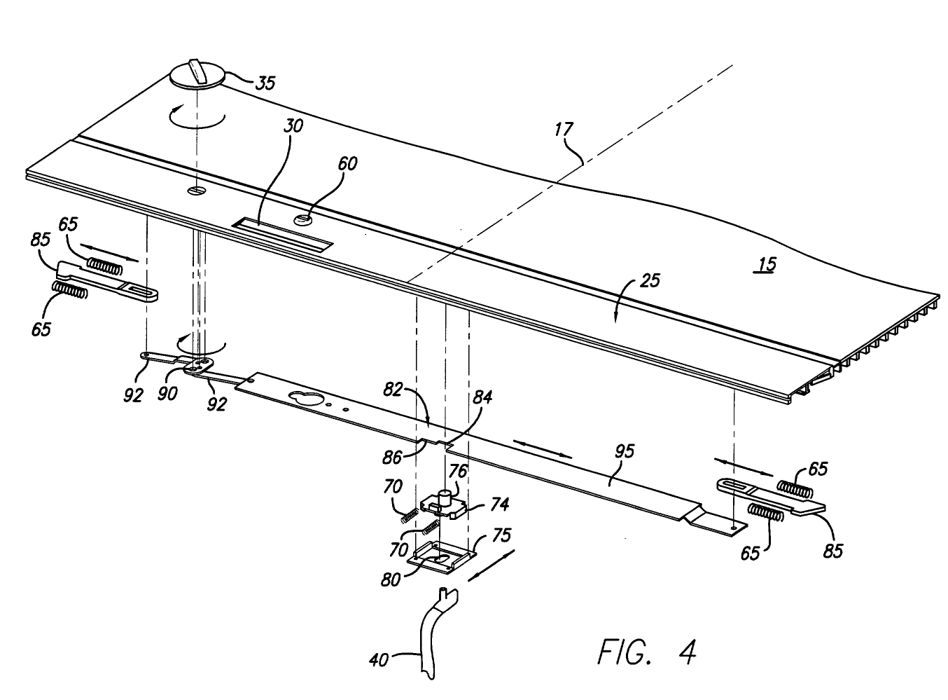

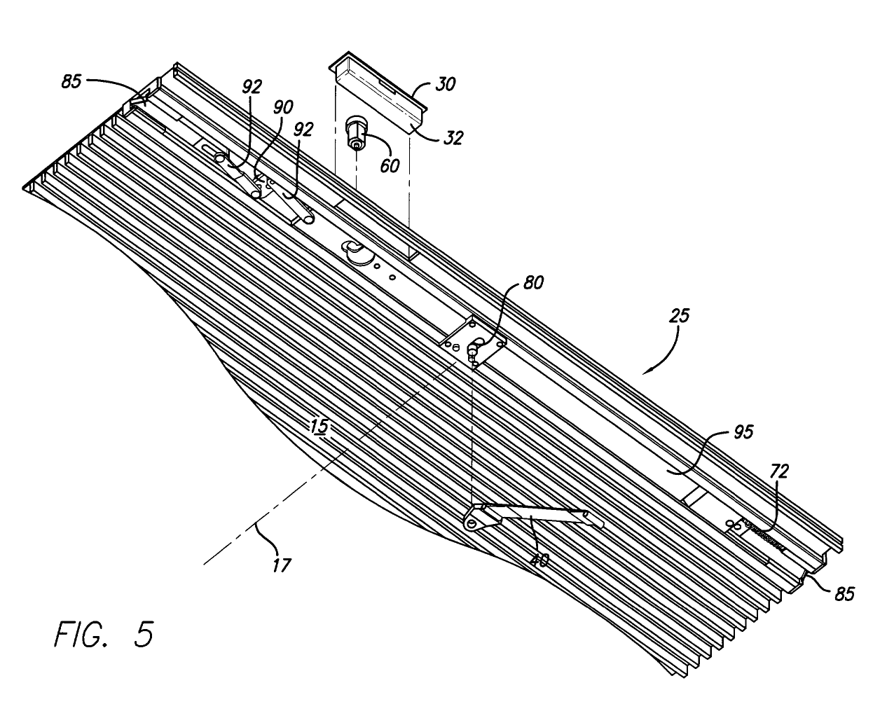

Illustrated in FIGS. 4-5 is the control assembly 25 located at the end of the cover 15. The control assembly 25 includes several features that allow the cover 15 to be located at different positions along the truck bed 12 and which facilitate the easy operation of the retractable cover 10. For example, the control assembly 25 includes an offset handle 30. In a preferred embodiment, the offset handle 30 is located on the driver's side of the truck bed 12. Specifically, the offset handle 30 is not located along the cover centerline 17, but rather is offset towards the driver's side of the truck bed 12. Alternative embodiments may position the offset handle 30 in other locations. For example, the offset handle 30 may be located near an edge of the cover 15 or may be located on the passenger side of the cover 15. Alternatively, two offset handles 30 may be located on the control assembly 25, with one offset handle 30 located on the driver side of the cover 15 and the second offset handle 30 located on the passenger side of the cover 15. In a preferred embodiment, the handle 30 comprises a substantially rectangular shaped structure having an opening sized to receive the fingertips of an operator. Illustrated in FIG. 5, a handle bottom surface 32 is recessed about ¾-inch from the upper surface of the control assembly 25. The width of the handle 30 is approximately 5 inches and is sized to comfortably receive the fingertips of an operator even if the operator is wearing gloves or mittens.

When fully extended, the cover 15 encloses the truck bed 12 and the control assembly 25 abuts the tailgate 42. The cover 15 and control assembly 25 completely enclose the truck bed 12 creating an enclosed volume that comprises the entire area located underneath the cover 15 and the control assembly 25, and the area located underneath the canister 20. This enclosed volume is protected from the elements and when secured by lock 60, objects placed in the enclosed volume are also protected from theft.

When the operator wishes to completely extend the cover 15 so that the control assembly 25 abuts the tailgate 42, the operator pulls on the pull-strap 40 and draws the cover 15 toward the tailgate 42. Alternatively, the operator may pull the cover 15 to the tailgate 42 by using the handle 30. Latches 85 engage notches 55 that are located in rails 50 (or in stop strips that are located in the rails 50) completely enclosing the truck bed 12. The cover 15 can then be securely locked by using the lock 60 which prevents the dial 35 from rotating. If the operator wishes to view the enclosed volume of the truck bed 12, he can activate light 45 by using the light switch 47. The light 45 is preferably located on the canister 20, but may also be located in other locations such as along the sides of the truck bed 12 or on the control assembly 25.

Again referring to FIGS. 4-5, when an operator wishes to access the truck bed 12 by retracting the cover 15, the operator turns the dial 35 which will retract the latches 85 into the control assembly 25. The latches 85 are pulled into the control assembly 25 by the rotation of the pivot member 90, which pulls on the links 92. Extension springs 65 which urge the latches 85 away from the control assembly 25 are compressed as the latches 85 are pulled into the control assembly 25. When the latches 85 are pulled into the control assembly 25, the cover 15 is pulled towards the canister 20 by tension generated by the reel located in the canister 20.

One feature of the present invention is that the cover 15 can be positioned in a location intermediate between the canister 20 and the tailgate 42 without first letting the cover 15 retract all the way forward to the canister 20. Conventional retractable covers having locking mechanisms must be retracted to the canister, which releases the latches, thereby allowing the cover to be pulled toward the tailgate into a specific position. This tedious extra step is eliminated by the present invention which can be released at the tailgate 42 and then directly locked into a position intermediate between the canister 20 and the tailgate 42.

First, the cover 15 is unlocked by rotating the dial 35 clockwise, which causes the pivot member 90 to also rotate, pulling the latches 85 into the control assembly 25. Specifically, the control assembly 25 includes two latches 85 that are connected to the dial 35 by a pivot member 90 that is connected to two links 92. One link 92 slidingly engages one latch 85 while a second link 92 is pivotably coupled to a translation member 95 that slidingly engages latch 85. Once the latches 85 are pulled into the control assembly 25, the cover 15, sliding on rails 50, is pulled toward the canister 20 by tension created by the reel located in the canister 20. As shown in FIG. 2, each rail 50 includes several notches 55 that are sized to engage with the latches 85, or as discussed above, a stop strip may be positioned in each rail 50, with the stop strip containing either notches 55, or projections sized to engage the latches 85.

Referring to FIGS. 4-5, to engage the latches 85 with the notches 55, the operator pulls on pull-strap 40, which slides in cover plate slot 80. Pull-strap 40 is coupled to the actuator 74 by a fastener or other suitable device that extends through the cover plate 75 into the actuator 74. The actuator 74 includes a projection 76 that is forced by the compression springs 70 into the foot 84 of the L-shaped notch 82. When the projection 76 is located in the foot 84, the translation member 95 is fixed in position and the latches 85 remain retracted in the control assembly 25. By pulling on the pull-strap 40, the projection 76 moves in slot 80 and is pulled out of the foot 84, releasing the translation member 95, and moving the projection 76 into the body 86 of the L-shaped notch 82. The translation member 95 is urged by translation spring 72 to move, and as the translation member 95 moves, the dial 35 rotates counter-clockwise, which rotates pivot member 90 counter-clockwise, which releases latches 85 so that they project out of the control assembly 25.

Simply put, by pulling on the pull-strap 40, the latches 85 are released, thereby permitting them to engage with notches 55 located in the rails 50. The latches include an angled surface so as to allow the cover 15 to be pulled towards the tailgate 42 without catching in the notches 55.

To position the cover 15 in a position intermediate between the canister 20 and the tailgate 42, first, the operator rotates the dial 35 clockwise, thereby retracting the latches 85 into the control assembly 25. Tension created by the reel located in the canister 20 now pulls the cover 15 toward the canister 20. The operator then grasps the pull-strap 40 and positions the cover 15 in its desired location. The operator then lightly jerks the pull-strap 40 which releases the latches 85 as described above, permitting them to engage with notches 55. One feature of the present invention is that the cover 15 can be securely positioned in several different locations intermediate of the canister 20 and tailgate 42. Advantageously, this operation can be performed from the rear of the vehicle, adjacent to the tailgate 42. This contrasts with conventional cover systems that must be either operated from the front of the truck bed or require the cover to be retracted to the truck cab before it can be locked into an intermediate position.

Thus, it is seen that an apparatus and method for enclosing cargo areas, such as a pickup truck bed, is provided. One skilled in the art will appreciate that the present invention can be practiced by other than the above-described embodiments, which are presented in this description for purposes of illustration and not of limitation. The description and examples set forth in this specification and associated drawings only set forth preferred embodiment(s) of the present invention. The specification and drawings are not intended to limit the exclusionary scope of this patent document. Many designs other than the above-described embodiments will fall within the literal and/or legal scope of the following claims, and the present invention is limited only by the claims that follow. It is noted that various equivalents for the particular embodiments discussed in this description may practice the invention as well.

What is claimed is:

1. An enclosure for a vehicle bed, comprising:
a cover structured to moveably extend over an area of the vehicle bed; and
a light located within the area.

2. The enclosure of claim 30, wherein the vehicle bed is selected from the group consisting of: a pickup truck utility bed, a pickup truck bed, a part of a truck that is designed to carry items, a part of a sport utility vehicle that is designed to carry items, a part of a land vehicle that is designed to carry items, and a part of a boat that is designed to carry items.

3. The enclosure of claim 30, wherein the area where the light is located is selected from the group consisting of: a canister that is structured to receive the cover; a tailgate, a side of a truck bed, an underside of the cover, and a cover control assembly.

4. The enclosure of claim 30, wherein the light is selected from the group consisting of: halogen, incandescent, light emitting diode, and florescent.

5. An enclosure for a vehicle bed, comprising:
a moveable cover having a centerline; and
a handle located on the moveable cover, the handle offset from the centerline.

6. The enclosure of claim 5, wherein the centerline comprises an imaginary line that divides the cover into two sections of equal area.

7. The enclosure of claim 5, wherein the handle is structured to receive a part of a hand of an operator.

8. The enclosure of claim 5, wherein the handle is located on the cover in a position that can range from about 0.25 inch to about 30 inches from the centerline.

9. An enclosure for a vehicle bed, comprising:
a moveable cover structured to be retractable into a canister having a rail guide; and
a rail structured to slidably engage the rail guide so that the canister is suspended by the rail above a vehicle bed floor.

10. The enclosure of claim 9, further including a plurality of notches located in the rail.

11. The enclosure of claim 9, further including a plurality of notches located in a stop strip that is positioned in the rail.

12. The enclosure of claim 9, further including a light located on the canister.

13. The enclosure of claim 9, further including a handle located on the cover, the handle offset from a centerline of the cover, wherein the centerline comprises an imaginary line that divides the cover into two sections of substantially equal area.

14. The enclosure of claim 13, wherein the handle is structured to receive a part of a hand of an operator.

15. A control assembly for a moveable vehicle enclosure, comprising:
a latch slidably coupled to a translation member;
an actuator releaseably engageable with the translation member, the actuator structured to release the translation member so that the latch will extend from a side of the control assembly.

17. The control assembly of claim 15, wherein the latch is sized to engage a notch or a projection located in a rail.

18. The control assembly of claim 15, wherein the translation member is slidably mounted in the control assembly, and includes a notch for receiving the actuator.

19. The control assembly of claim 18, wherein the translation member is held in a position when the actuator is located in the notch.

20. The control assembly of claim 18, wherein the translation member is capable of a movement when the actuator is moved out of the notch.

21. The control assembly of claim 15, further including a pivot member coupled to the translation member, the pivot member structured to adjust a position of the translation member.

22. The control assembly of claim 15, further including a lock structured to fix a position of the translation member.

23. The control assembly of claim 15, further including a handle located on the control assembly, the handle offset from a centerline of the control assembly, wherein the centerline comprises an imaginary line that divides the cover into two sections of substantially equal area.

24. A method of positioning a moveable cover by an operator, the cover sized to enclose a vehicle bed having a front and a rear, the method comprising the steps of:
providing a cover having an end section;
positioning the end section adjacent to the rear of the vehicle bed;
releasing the cover so that the cover moves toward the front of the vehicle bed;
positioning the cover between the front and the rear of the vehicle bed, with the operator located adjacent to the rear of the vehicle bed.
